(19) United States
(12) Patent Application Publication
(10) Pub. No.: US 2004/0183668 A1
(43) Pub. Date: Sep. 23, 2004

(54) Interactive video monitoring (IVM) process

(76) Inventors: Robert Colin Campbell, Cheney, WA (US); Wade Allen Taylor, Spokane, WA (US)

Correspondence Address: ROBERT COLIN CAMPBELL, 15216 WEST THIRD ADDITION ROAD, CHENEY, WA, 99004, US

(21) Appl. No.: 10/804,543

(22) Filed: Mar. 19, 2004

Related U.S. Application Data
(60) Provisional application No. 60/456,668, filed on Mar. 20, 2003.

(51) Int. Cl. G08B 29/00

(52) U.S. Cl. 340/506; 348/152; 340/531

(57) ABSTRACT

The invention utilizes an alarm input device and an intrusion detection system and/or video device. When the intrusion detection system and/or video device detects an alarm condition the alarm signal is transmitted to the central station. The alarm signal is then processed by the alarm processing device and/or the central station software. The central station software places the alarm signal into a queue along with the other alarm signals which are waiting for delivery to the next available operator. The central station software selects the highest priority alarm signal, combines the alarm signal and customer account record and delivers it to the next available operator. When the operator's alarm screen displays the alarm description, the account information for the video device is forwarded to establish a connection to the video device. The video from the video device is then displayed for the operator to view.

### FIELD OF THE INVENTION

This invention will document a process to verify alarm signals from an unlimited number of intrusion detection systems and/or video devices. This process utilizes video to provide additional information to a central station operator at a central station, but more particularly, this invention will document how to associate a video device with an alarm signal to facilitate the connection between the central station and the monitored location's video device after the alarm signal from the monitored location has been received by the central station.

### BACKGROUND OF THE INVENTION

False Alarms caused by Intrusion detection systems are increasing in number every year. The number of false alarms Police and Fire Departments respond to far exceed the number of legitimate alarms. Central stations dispatch the Police and Fire Departments when they are notified of the possibility of an event (burglary, holdup, fire alarm etc.) rather than when an event has been verified (with video) by the central station operator. It is the intention of this invention to provide central station operators the opportunity to verify (with video) all incoming alarm signals from any monitored location prior to dispatching anyone to the monitored location. This process will significantly reduce the number of times Police and Fire Departments are required to respond to false alarms. Since the mid-1990's video devices have been capable of transmitting video to central stations. However, central stations have not been able to utilize video devices to verify alarm signals because video devices cannot be monitored using the same process as intrusion detection devices.

An understanding of the current process of monitoring intrusion detection devices is provided to appreciate the problems associated with attempting to monitor video devices using the same process.

Example of the current process used to monitor intrusion detection devices: National Alarm Computer Center (NACC/www.nacchq.com) monitors upwards of 250,000 intrusion detection devices at as many monitored locations. They accomplish this by utilizing alarm processing devices (alarm receivers) to receive alarm signals (account number, event type, event time) from intrusion detection devices. The intrusion detection devices typically communicate to the alarm processing device using a standard telephone line.

The alarm processing device's function is to captures the alarm signal and then disconnects the incoming phone line to make the phone line available for the next intrusion detection device at the central station, and for the operator to call the monitored location and verify the alarm siganal

After the alarm processing device receives the signal and disconnects from the intrusion detection device the alarm processing device transfers the alarm signal to the central station software. The central station software places the alarm signal into a queue along with the other alarm signals which are waiting for delivery to the next available operator. The queue prioritizes the alarm signals by type (fire, medical panic, hold up, burglary, etc.) and event time. The central station software selects the highest priority alarm signal, combines the alarm signal with the customer account record (address, owner's phone number, who to call list, response instructions, local police department phone number, local fire department phone number, etc.), and delivers the alarm condition with the customer account record to the next available operator.

Example Response by an Operator to a Burglary: The operator calls the monitored location's phone number and asks the person who answers the phone for their name and password. If there is no answer at the location or the person who answers doesn't know the password, the operator dispatches the police.

NACC uses central station software manufactured by Monitoring Automation Systems (MAS/www.monauto.com) to accomplish the above example. MAS and other video device manufacturers were contacted and asked to create a solution for NACC. NACC began marketing Interactive Video Monitoring services in with permission from the inventors to use the IVM process. The inventors created the process of Interactive Video Monitoring (IVM) after a detailed investigation of the present process of monitoring intrusion detection devices. In order to test the new IVM process of a prototype application needed to be created. This required software modifications to a central station monitoring software and to a video device manufacturers software.

The IVM process is required to monitor a large number of video devices.

Listed below are the methods currently being deployed by central stations to monitor video devices:

Solution 1: Fulltime connections display video to the central station by connecting to the video device on a continuous basis (one client to one video device).

Solution 2: Fulltime connections display video to the central station by connecting to the video device on a continuous basis (one client to a limited number of video devices).

Solution 3: When there is an alarm condition the video device contacts, connects to and streams video to the central station and displays the video to the central station operator (one video device to one client).

Solution 4: When there is an alarm condition the video device contacts, connects to and streams video to the central station and displays the video to the central station operator (limited number of video devices to one client).

Solution 5: When there is an alarm condition the video device contacts, connects to and streams video to the central station and stores the streaming video to a video storage device within the central station (limited number of video devices to one client).

Solution 6: The central station operator manually connects to the video device.

Listed below are the short comings of the current solutions listed above.

Solution 1: This method is very labor intensive, resource intensive and cost prohibitive.

Solution 2: This method is very labor intensive, resource intensive and cost prohibitive.

Solution 3: This method limits the number of alarm conditions and cannot ensure the central station will receive the video when there is an alarm condition if they are onitoring more than one account.

Solution 4: This method limits the number of alarm conditions and cannot ensure the central station will receive the video when there is an alarm condition if they are onitoring more than one account.

Solution 5: This method limits the number of alarm conditions and cannot ensure the central station will receive the video when there is an alarm condition if they are onitoring more than one account.

Solution 6: This method introduces the element of human error to connect to the video device by requiring the central station operator to manually enter the necessary account information to connect to the video device and is very labor intensive, resource intensive, cost prohibitive and creates a security breach.

It is therefore an object of the invention to . . .

verify alarms from intrusion detection systems using video devices at monitored locations

It is therefore an object of the invention to . . .

monitor video from an unlimited number of video devices, utilizing a variety of video delivery methods and connections from a central monitoring location

It is another object of the invention to . . .

seamlessly integrate the process of interactive video monitoring with the present process of monitoring alarm signals from intrusion detection systems

It is another object of the invention to . . .

utilize a data base to store the video device connection information

It is another object of the invention to . . .

reduce the amount of time that is required to verify an alarm with a video device

It is another object of the invention to . . .

reduce the human error involved with the process of connecting to a video device

It is another object of the invention to . . .

reduce the number of false alarms for police, fire and emergency response teams

It is another object of the invention to . . .

reduce the central station's cost associated with verifying alarm signals using video devices

It is another object of the invention to . . .

reduce the consumer's cost of having their alarm signals verified with video devices

It is another object of the invention to . . .

increase the services provided by central stations

It is another object of the invention to . . .

solve the problem of answering, prioritizing, queuing and routing alarm conditions associated with monitoring video devices within a central station

It is another object of the invention to . . .

have IVM operate without having to integrate the intrusion detection device with the video device at the monitored location

It is another object of the invention to . . .

allow the central station the choice of viewing the video on the same monitor they use to monitor intrusion detection devices or at their option view it on a separate monitor

### SUMMARY OF THE INVENTION

In accordance with the present invention, there is provided a process to monitor and verify alarm conditions from an unlimited number of video devices within a central station. This invention solves the problem of answering, prioritizing, queuing and routing incoming alarm signals by integrating the current method of monitoring alarm signals from intrusion detection systems with a new process for the central station to connect to a video device (at the monitored location) when an alarm condition has occurred. The invention utilizes an alarm input device connected to an intrusion detection system or video device. When the intrusion or video device detects an alarm condition the alarm signal is transmitted over the transmission medium to the central station. The alarm signal is then processed by the alarm processing device and/or the central station software. The central station software places the alarm signal into a queue along with the other alarm signals which are waiting for delivery to the next available operator. The queue prioritizes the alarm signals by type (fire, medical panic, hold up, burglary, etc.) and event time. The central station software selects the highest priority alarm signal, combines the alarm signal with the customer account record (address, owner's phone number, who to call list, response instructions, local police department phone number, local fire department phone number, etc.), and delivers the alarm condition with the customer account record to the next available operator. The central station software displays the alarm condition on the operators alarm screen, the account information for the video device is forwarded either automatically by the software or manually by the operator to establish a connection to the video device. The video from the video device is then displayed for the operator to view.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an overview view of an Interactive Video Monitoring Process.

For purposes of clarity and brevity, like elements and components will bear the same designations and numbering throughout the FIGURES.

### DESCRIPTION OF THE PREFERRED EMBODIMENT

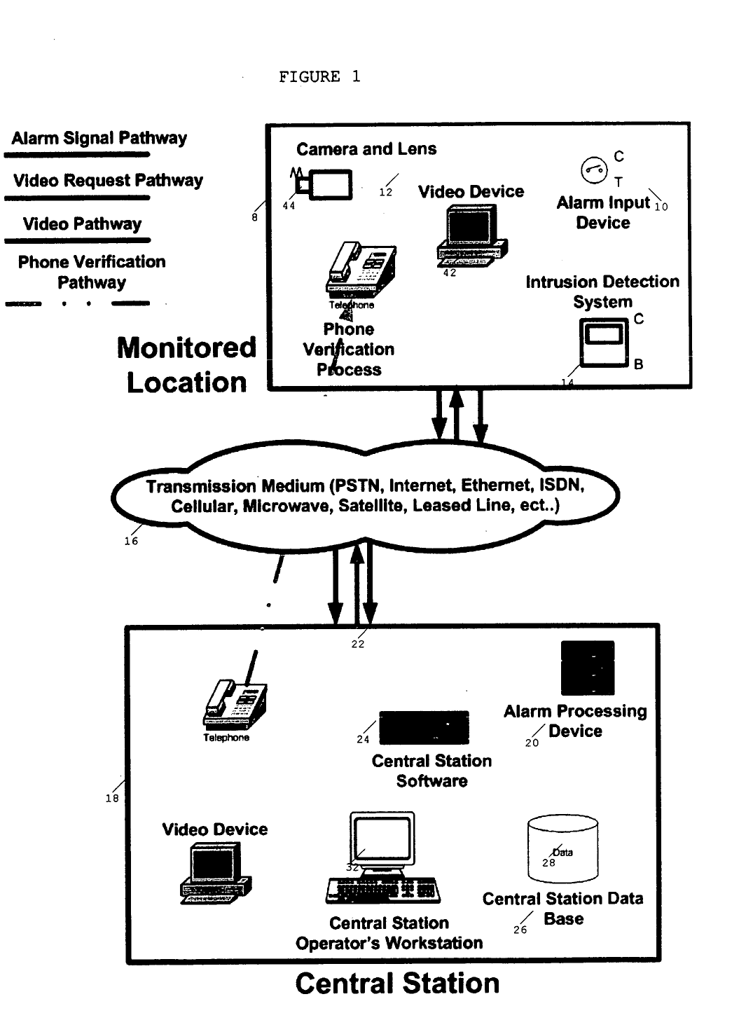

FIG. 1 is an overview of the Interactive Video Monitoring process

Generally speaking, the invention referred to as Interactive Video Monitoring (IVM) pertains to a process of monitoring video in a central station 18.

Now referring to FIG. 1:

The monitored location 8 consists of the following elements:

1. alarm input device 10

a. Door and Window Contacts—Examples of door and window contacts will be Ademco part number PAL-T, 943, 950, 7940, PR-20439 these are just a few examples of door contacts that are available. There are many other manufactures that make this device.

b. Motion Detection Sensors—Examples of motion detection sensors will be Ademco part number 998, 998Pi, Rx4GLD, 995 these are just a few. There are many other manufactures that make this device.

d. Glass Break Detectors—Examples of glass break detectors will be Ademco part number ASC25, ASC25R, 2520, 5849 these are just a few. There are many other manufactures that make this device.

e. Smoke and Heat Detectors—Examples of smoke and heat detectors will be Ademco part number 5807LS, 5807LST, 5808LST these are just a few examples. There are many other manufactures that make this device.

f. Carbon monoxide detectors—Examples of carbon monoxide detectors will be GE Interlogix part number 240 Series SafeAir® Carbon Monoxide Alarm this is just an example. There are many other manufactures that make this device.

g. Panic Buttons—Examples of panic buttons will be Ademco part number 264, 266, 268, these are just a few examples. There are many other manufactures that make this device.

h. Medical Alert Buttons—Examples of medical alert buttons will be GE Interlogix part number 60-452-10-319.5 this is just an example. There are many other manufactures that make this device.

i. Hold up Button—Examples of hold up button will be Ademco part number 264, 266, 268, these are just a few examples. There are many other manufactures that make this device.

j. Card Access Reader—Examples of card access reader will be Rutherford Controls part number 9320, 9321, 9322 these are just a few examples. There are many other manufactures that make this device.

2. connection medium 12

a. UTP cables

b. Coaxial cable

c. Stand copper wiring

i. 2 conductor wire

ii. 4 conductor wire

d. Wireless

e. other connection mediums

3. intrusion detection system 14

a. Alarm Panel

i. DSC—Part number NT9010, Power 864, Power 832

ii. Ademco—Vista-10P, Vista-40, LYNXR-EN

iii. DMP—XR20, XR200A, XR200L

b. Access Control Panel

i. Kantech—EntraPass

ii. DMP—XR200

c. Digital Video Recorders

i. Cascadia—XM 24048016R

ii. Pelco—DX-7000

iii. Philips—DESA

iv. Kalatel—DVMRe

d. Web Servers

i. Panasonic—NT-104

ii. OZVision—4VC

e. Other Monitoring Devices

4. video device 42

a. Digital Video Recorders

i. Cascadia—XM 24048016R

ii. Pelco—DX-7000

iii. Philips—DESA

iv. Kalatel—DVMR

b. Video Servers

c. Intrusion detecton sytem with a means of transmitting video

d. Web Servers

i. Panasonic—NT-104

ii. OZVision—4VC

e. Web Cameras

i. CNB—W1000

5. camera and lens 44

a. Cascadia

i. HCC745N—13VM308AS

ii. HB24E—13VM550AS

iii. HCC645—13VM612AS

transmission medium 16 consists of the following

1. PSTN

2. Internet

3. Ethernet

4. ISDN

5. Cellular

6. Microwave

7. Satellite

8. Leased Line

9. Other Communication Mediums

The central station 18 consists of the following

1. alarm processing device 20

a. Alarm Receiver—DMP—SCS-1R

b. PC based receiver software—Heitel Video Server

2. central station software 24

a. MAS

b. SIS

c. SIM

d. DICE

3. central station data base 26

a. customer account record 28

b. site connection information

4. central station operator's workstation 32

In accordance with the present invention, there is provided a process to monitor and verify alarm conditions from an unlimited number of video devices within a central station 18.

In operation, this invention solves the problem of answering, prioritizing, queuing and routing incoming alarm signals by integrating the current method of monitoring alarm signals from intrusion detection systems with a new process for the central station 18 to connect to a video device 42 (at the monitored location 8) when an alarm condition has occurred. The invention utilizes an alarm input device 10 connected to an intrusion detection system 14 or video device 42. When the intrusion or video device 42 detects an alarm condition the alarm signal 22 is transmitted over the transmission medium 16 to the central station 18. The alarm signal 22 is then processed by the alarm processing device 20 and/or the central station software 24. The central station software 24 places the alarm signal 22 into a queue along with the other alarm signals which are waiting for delivery to the next available operator. The queue prioritizes the alarm signals by type (fire, medical panic, hold up, burglary, etc.) and event time. The central station software 24 selects the highest priority alarm signal 22, combines the alarm signal 22 with the customer account record 28 (address, owner's phone number, who to call list, response instructions, local police department phone number, local fire department phone number, etc.), and delivers the alarm signal 22 with the customer account record 28 to the next available operator. The central station software 24 displays the alarm condition on the operators alarm screen, the account information for the video device 42 is forwarded either automatically by the software or manually by the operator to establish a connection to the video device 42. The video from the video device 42 is then displayed for the operator to view.

Listed below is an example of how a central station software 24 manufacturer has implemented Interactive Video Monitoring (IVM):

Cascadia Video Interface

1.0 Scope

This document describes the software settings in MASterMind central station 18 Monitoring Software required to enable integration with Cascadia Video Devices using the Cascadia IVM software. The following items are assumed to be available and/or installed:

MASterMind Monitoring version 6.14.01 (Build 8 or later.)

Cascadia IVM software.

2.0 Overview

The Cascadia IVM software typically resides on the Operator's workstation along side the MASterMind Monitoring application. Both applications have been enabled to communicate with one another using standard TCP/IP. MASterMind software automates the connection process of the Cascadia's IVM software by transmitting data (IP Address, Site Code, User Name and Password) to initiate the connection of the Cascadia's IVM software to Cascadia Video Devices.

3.0 Basic Operation

When a video alarm is pulled down in the Alarm Dispatch window, MASterMind Monitoring initiates the TCP/IP connection to Cascadia's Video Devices. Once the connection is established between these two applications, MASterMind Monitoring proceeds to send commands to Cascadia's IVM software to initiate the display of live video for the given site. The operator then controls all aspects of the video display within Cascadia's IVM software. When the operator has finished handling the alarm in MASterMind Monitoring and the Alarm Dispatch window is closed, the video connection to the site is closed and Cascadia's IVM software waits for another connection request from MASterMind Monitoring.

4.0 MASterMind Monitoring Setup

This section describes how to configure the MASterMind Monitoring application.

4.1 System Options

These are “system wide” parameters that will be the same for each dispatch operator.

AltSys Video Port—specifies the TCP/IP Listen port that MASterMind Monitoring uses to establish a connection with Cascadia's IVM software. This value must match the assigned Listen Port value configured for Cascadia's IVM software.

Video Types—specifies the supported video types. This value should always be set to “ALTSYS”.

4.2 Site Options

For each site enabled with Cascadia Video Devices, four Site Option values must be supplied which define how Cascadia's IVM software will connect to the site to retrieve video. These will be selectable in a lookup of available entries from the Options Setup window.

ALTSYS Site Code (ALTSYS_SITE_CODE)—defines the unique site identifier used by Cascadia's IVM software to connect to video equipment at the site.

ALTSYS Site IP Address (ALTSYS_SITE_IP)—specifies the IP Address that Cascadia's IVM software will use to route to video equipment at the site.

ALTSYS Site User Name (ALTSYS_SITE_USER)—used with the ALTSYS Site Password (below), this authenticates Cascadia's IVM software to access the video equipment at the Site.

ALTSYS Site Password (ALTSYS_SITE_PW)

4.3 Alarm Points

Process Options can be associated with either Events or Points. For an alarm to be “Cascadia video enabled”, the Process Option of “ALTSYS” must be provided in the Process Option field on either the Event or Point associated with the alarm event. The Process Option and Process Option Type of ALTSYS should already be available for selection.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An interactive video monitoring (ivm) process for verifying alarms signals from an unlimited number of intrusion detection systems and/or video devices utilizing video to provide additional information to a central station operator at a central station. comprising:
means for locating the intrusion detection system, video device, camera and lens the central station is monitoring;
means for creating video images;
means for transmitting and/or storing video;
means for detecting an alarm condition for the intrusion detection system;
means for connecting the alarm input device or camera and lens to the intrusion detection system or video device;
means for processing and transmitting alarm signal to the central station;
means for transporting alarm signal or video data to the central station;
means for locating the equipment for monitoring the intrusion detection system and/or video device at the monitored location;
means for receiving alarm signal from the monitored location;
means for indentifying the monitored location and communicating the event;
means for processing and serving the alarm signal to the central station operator's workstation;
means for storing the customer's account record;
means for storing customer's account number, account information and video device connection information; and
means for displaying the customer's account record, alarm signal and video.

2. The interactive video monitoring (ivm) process in accordance with claim 1, wherein said means for locating the intrusion detection system, video device, camera and lens the central station is monitoring comprises a monitored location.

3. The interactive video monitoring (ivm) process in accordance with claim 1, wherein said means for creating video images comprises a camera and lens.

4. The interactive video monitoring (ivm) process in accordance with claim 1, wherein said means for transmitting and/or storing video comprises a video device.

5. The interactive video monitoring (ivm) process in accordance with claim 1, wherein said means for detecting an alarm condition for the intrusion detection system comprises an alarm input device.

6. The interactive video monitoring (ivm) process in accordance with claim 1, wherein said means for connecting the alarm input device or camera and lens to the intrusion detection system or video device comprises a connection medium.

7. The interactive video monitoring (ivm) process in accordance with claim 1, wherein said means for processing and transmitting alarm signal to the central station comprises an intrusion detection system.

8. The interactive video monitoring (ivm) process in accordance with claim 1, wherein said means for transporting alarm signal or video data to the central station comprises a transmission medium.

9. The interactive video monitoring (ivm) process in accordance with claim 1, wherein said means for locating the equipment for monitoring the intrusion detection system and/or video device at the monitored location comprises a central station.

10. The interactive video monitoring (ivm) process in accordance with claim 1, wherein said means for receiving alarm signal from the monitored location comprises an alarm processing device.

11. The interactive video monitoring (ivm) process in accordance with claim 1, wherein said means for indentifying the monitored location and communicating the event comprises an alarm signal.

12. The interactive video monitoring (ivm) process in accordance with claim 1, wherein said means for processing and serving the alarm signal to the central station operator's workstation comprises a central station software.

13. The interactive video monitoring (ivm) process in accordance with claim 1, wherein said means for storing the customer's account record comprises a central station data base.

14. The interactive video monitoring (ivm) process in accordance with claim 1, wherein said means for storing customer's account number, account information and video device connection information comprises a customer account record.

15. The interactive video monitoring (ivm) process in accordance with claim 1, wherein said means for displaying the customer's account record, alarm signal and video comprises a central station operator's workstation.

16. An interactive video monitoring (ivm) process for verifying alarms signals from an unlimited number of intrusion detection systems and/or video devices utilizing video to provide additional information to a central station operator at a central station. comprising:
a monitored location, for locating the intrusion detection system, video device, camera and lens the central station is monitoring;
a camera and lens, for creating video images;
a video device, for transmitting and/or storing video;
an alarm input device, for detecting an alarm condition for the intrusion detection system;
a connection medium, for connecting the alarm input device or camera and lens to the intrusion detection system or video device;
an intrusion detection system, for processing and transmitting alarm signal to the central station;
a transmission medium, for transporting alarm signal or video data to the central station;
a central station, for locating the equipment for monitoring the intrusion detection system and/or video device at the monitored location;
an alarm processing device, for receiving alarm signal from the monitored location;
an alarm signal, for indentifying the monitored location and communicating the event;
a central station software, for processing and serving the alarm signal to the central station operator's workstation;
a central station data base, for storing the customer's account record;
a customer account record, for storing customer's account number, account information and video device connection information; and
a central station operator's workstation, for displaying the customer's account record, alarm signal and video.

17. An interactive video monitoring (ivm) process for verifying alarms signals from an unlimited number of intrusion detection systems and/or video devices utilizing video to provide additional information to a central station operator at a central station. comprising:
a monitored location, for locating the intrusion detection system, video device, camera and lens the central station is monitoring;
a camera and lens, for creating video images;
a video device, for transmitting and/or storing video;
an alarm input device, for detecting an alarm condition for the intrusion detection system;
a connection medium, for connecting the alarm input device or camera and lens to the intrusion detection system or video device;
an intrusion detection system, for processing and transmitting alarm signal to the central station;
a transmission medium, for transporting alarm signal or video data to the central station;
a central station, for locating the equipment for monitoring the intrusion detection system and/or video device at the monitored location;
an alarm processing device, for receiving alarm signal from the monitored location;
an alarm signal, for indentifying the monitored location and communicating the event;
a central station software, for processing and serving the alarm signal to the central station operator's workstation;
a central station data base, for storing the customer's account record;
a customer account record, for storing customer's account number, account information and video device connection information; and
a central station operator's workstation, for displaying the customer's account record, alarm signal and video.
